(19) United States
(12) Patent Application Publication
(10) Pub. No.: US 2026/0229604 A1
(43) Pub. Date: Aug. 6, 2026

(54) UNITIZED SOLID-STATE BATTERY CELL AND ASSEMBLY

(71) Applicant: FORD GLOBAL TECHNOLOGIES, LLC, Dearborn, MI (US)

(72) Inventors: Zijie LU, Novi, MI (US); Hyukkeun OH, Ann Arbor, MI (US); Wenhui ZHU, Northville, MI (US); Yongcai WANG, Ann Arbor, MI (US)

(21) Appl. No.: 19/044,916

(22) Filed: Feb. 4, 2025

(51) Int. Cl. H01M 10/0585; H01M 4/66; H01M 10/0562

(52) U.S. Cl. CPC H01M 10/0585; H01M 4/662; H01M 10/0562; H01M 2300/0065

(57) ABSTRACT

A solid-state battery is assembled from a set of unitized solid-state battery cells. Each unitized cell includes a stainless steel current collector laminated on one side with three layers of solid electrolyte. The three layers include a negative active material layer, a separator layer, and a positive active material layer. One of the layers may be coated directly onto the current collector. The other two layers may be coated onto a carrier film and then transferred. All three layers are densified together. When assembled into a series connected battery structure, the only interface between layers that were not densified together is an electron migration interface. All ion migration interfaces are densified together, reducing resistance.

### TECHNICAL FIELD

The disclosure relates to the general field of solid-state batteries. More particularly, the disclosure relates to a solid-state battery arrangement and corresponding method of fabrication.

### BACKGROUND

Solid-state batteries are widely viewed as a next generation battery technology for electrical vehicle applications, due to the ability to enable high-energy density anode and cathode materials. Compared to lithium (Li)-ion batteries, where a liquid electrolyte freely carries Li-ions, solid-state batteries are composed of solid particles, and Li-ions diffuse from one phase to another by migration across a solid interface.

Solid-state batteries, like other types of batteries, may be composed of a number of battery cells connected together. If the cells are connected in parallel, the overall battery voltage is equal to the voltage of each cell and the current capability of the battery is equal to the sum of the current capabilities of each cell. If the cells are connected in series, the battery voltage is equal to the sum of the voltages of the cells and the current capability of the battery is equal to the current capability of individual cells.

### SUMMARY

A method of fabricating a solid-state battery includes forming a single-sided electrode, forming a free-standing electrode, and laminating a solid electrolyte separator layer between the single-sided electrode and free-standing electrode to form a unitized solid-state cell. The single-sided electrode is formed by coating a current collector with a first active material. The free-standing electrode is formed by coating a carrier film with a second active material. The first active material may be a negative active material. The second active material may be a positive active material. The laminating may include laminating the solid electrolyte separator with the single-sided electrode to form a unit and then laminating the unit with the free-standing electrode. The laminating may also include applying a first pressure between about 50 MPa and 300 MPa. A plurality of the unitized solid-state cells may be arranged between a bottom current collector and a top current collector to form a stack. A second pressure greater than the first pressure may be applied to the stack. The second pressure may be between about 300 MPa and 500 MPa. The current collectors of the unitized solid-state cells may be tab free while the top current collector and the bottom current collector have tabs extending beyond perimeters of the unitized solid-state cells.

A unitized solid-state battery cell includes a current collector with a negative active material layer, a separator layer, and a positive active material layer. The current collector has an active material free side. The current collector may be stainless steel. The current collector may be tab free.

A solid-state battery includes a plurality of unitized solid-state battery cells compressed in a stack. Each of the unitized solid-state battery cells may have a current collector laminated on a first side with a negative active material layer, a positive active material layer, and a solid electrolyte separator layer between the negative and positive active material layers such that one of the negative and positive active material layers is in direct contact with the current collector. A second side of each of the current collectors may be in direct contact with one of the negative active material layer or the positive active material layer of an adjacent cell. The solid-state battery may also include a top current collector and bottom current collector on opposite ends of the stack. The solid-state battery may include an air-tight housing surrounding the stack.

### BRIEF DESCRIPTION OF THE DRAWINGS

FIG. 1 is cross-sectional view of a single cell solid-state battery.

FIG. 2A is a cross-sectional view of a first solid-state battery subassembly.

FIG. 2B is a cross-sectional view of a second solid-state battery subassembly.

FIG. 3 is a cross-sectional view of a parallel connected multiple cell solid-state battery using the subassemblies of FIGS. 2A and 2B.

FIG. 4A is a pictorial view of a first intermediate product for fabricating a unitized solid-state battery cell.

FIG. 4B is a pictorial view of a second intermediate product for fabricating a unitized solid-state battery cell.

FIG. 4C is a pictorial view of a third intermediate product for fabricating a unitized solid-state battery cell.

FIG. 5 is a cross-sectional view of a unitized solid-state battery cell which may be fabricated from the intermediate products of FIG. 4A-4C.

FIG. 6 is a cross-sectional view of a series connected multiple cell solid-state battery using the unitized solid-state battery cell of FIG. 5.

FIG. 7 is a flow chart for a process of fabricating the unitized solid-state battery cell of FIG. 5.

FIG. 8 is a flowchart for a process of assembling the multiple cell solid-state battery of FIG. 6 using the unitized solid-state battery cell of FIG. 5.

### DETAILED DESCRIPTION

As required, detailed embodiments of the present invention are disclosed herein. The disclosed embodiments are merely exemplary of the invention that may be embodied in various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present invention.

Compared to lithium-ion batteries, which use a liquid electrolyte to freely carry Li-ions, solid-state batteries include solid components. In these systems, Li-ions migrate across solid interfaces between various phases. These interfaces exist not only between the electrodes (both anode and cathode) and the solid electrolyte separator but also within electrodes, and between active materials. Consequently, interfaces are among factors limiting the electrochemical performance of solid-state batteries.

To address the charge transport resistance across these interfaces, anodes, cathodes, and solid electrolyte separators are often calendared and laminated under high pressure. However, the interface between a highly densified electrode and separator can be highly resistive to lithium-ion transport. This is due to the surface becoming excessively flat and hard during densification, leading to mostly point-contact between layers.

These interfaces are characterized as ion-conducting interfaces, distinct from electron-conducting interfaces, which exist between the electrode and the current collector and allow only electron flow.

A common approach to mitigating this issue is to combine multiple layers during the assembly process. For instance, a solid-electrolyte separator can be laminated onto an electrode (either anode or cathode) at intermediate pressure (e.g., 50-300 MPa). Subsequently, a second electrode is added to the other side of the solid-electrolyte separator, and the entire assembly is fully densified at higher pressure (e.g., 300-500 MPa) to form a full cell. However, because electrodes are typically double-side coated in current manufacturing processes, densification inevitably results in the exposure of fully densified flat surfaces. While this method reduces interfacial resistance for lithium-ion transport, it cannot completely eliminate it.

A solid-state battery manufacturing and stacking strategy has been developed to address the issue of high interfacial resistance for lithium-ion transport by not exposing densified flat electrode surfaces. This strategy, in some embodiments, incorporates two component-level architectures—a free-standing electrode (e.g., cathode) and a unitized single cell—and involves several manufacturing steps.

In the first step, a free-standing electrode is manufactured. One electrode, such as an anode, is coated onto a stainless-steel current collector, while the solid electrolyte separator and another electrode, such as a cathode, are each coated onto respective carrier films, such as polyethylene terephthalate (PET). This design eliminates the need for double-side coating of electrodes, significantly simplifying the manufacturing process.

In the second step, the layers created in the previous step—including a silicon anode on a stainless-steel current collector, a solid electrolyte separator on a PET film, and a lithium nickel manganese cobalt oxide (NMC) composite cathode on a PET film for example—are hot-pressed to form a unitized single cell. Different sequences can be used to combine the coated layers. For example, the solid electrolyte separator may first be laminated onto the silicon anode at a lower pressure, followed by the addition of the free-standing cathode. The assembly is then hot-pressed at higher pressure to fully densify the layers and form a unitized single cell. Using a slightly larger separator size can help prevent direct contact between the anode and cathode, reducing the likelihood of short circuits.

In the third step, the unitized single cells are stacked together to form a solid-state battery. In this architecture, an electron-conducting interface exists between a densified electrode and an adjacent current collector. Electron conduction is inherently faster and easier to optimize in solid-state systems than lithium-ion conduction across ion-conducting interfaces. For example, to enhance electrical conduction between adjacent unitized single cells, a conductive agent such as silver paste can be applied to the back of the stainless-steel current collector. For the complete unitized cell stack, additional current collectors can be attached to both ends of the SSB stack as bus bars.

In the final step, the stacked solid-state battery is packed in an air-tight enclosure, and appropriate compression is applied to the stack.

This solid-state battery architecture and manufacturing process facilitates lithium-ion transport across interfaces between adjacent layers, achieving high performance, including energy density and rate capability. The design requires only one current collector per unitized cell, which increases energy density. It also simplifies electrical wiring by eliminating tab components. Another potential advantage is the removal of the double-side coating process, which reduces manufacturing complexity.

A feature of this solid-state battery is the use of a single current collector and the absence of tab welding. This characteristic, along with the unique cell architectures such as the free-standing electrode and unitized cell, can serve as identifiers of use in the field.

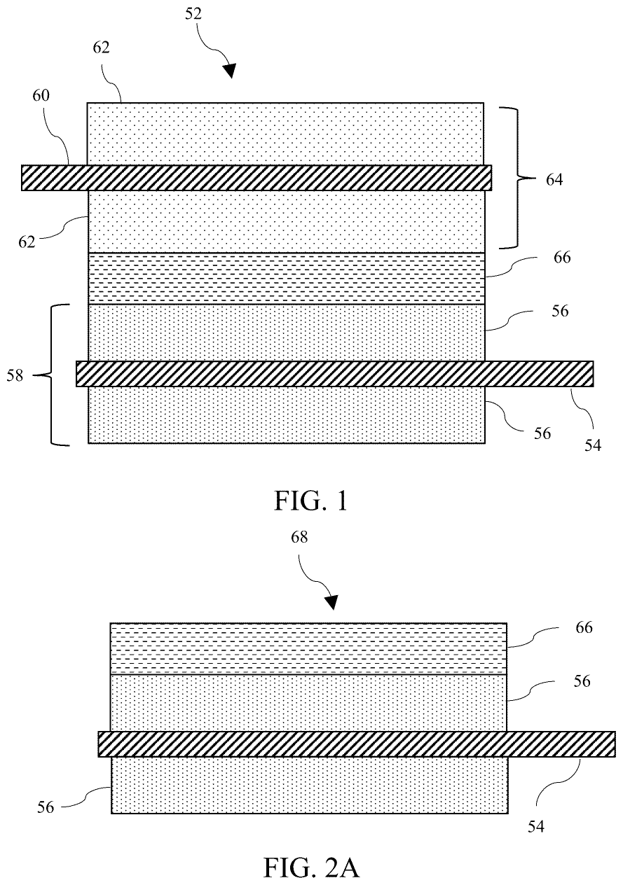

FIG. 1 schematically illustrates a single cell solid-state battery 52. The battery 52 includes a copper foil current collector 54 and active material layers 56 forming an anode 58, and an aluminum foil current collector 60 and active material layers 62 forming a cathode 64. A solid electrolyte separator 66 separates the anode 58 and cathode 64. During operation, ions, such as Li-ions, migrate between layers across the inter-layer boundaries.

The process used for fabrication and assembly changes the resistance to ion migration. The layers are calendared and densified at high pressures. If adjacent layers are densified separately before assembly, the surfaces become flat and hard during the densification process as mentioned previously. This results in a relatively high ion resistance at the boundary between layers. If adjacent layers are first assembled and then densified together, the ion resistance at the boundary is substantially reduced. However, there are physical limits to how many layers can be densified at a time.

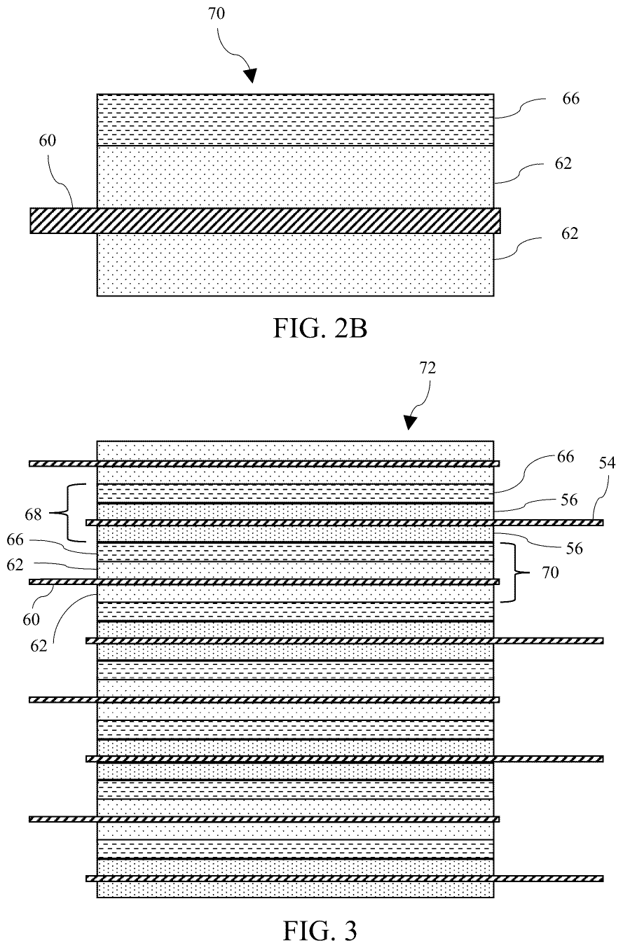

FIG. 2A shows an anode unit 68 for use in assembling a multiple cell solid-state battery. The current collector 54, which may be a copper foil, is coated on both sides with the active material layers 56. The solid electrolyte separator 66 is then laminated onto one of the active material layers 56 at an intermediate pressure (about 50-300 MPa). This results in the top and bottom surfaces of the anode unit 68 being flat and hard as described previously. Similarly, FIG. 2B shows a cathode unit 70. The current collector 60, which may be an aluminum foil, is coated on both sides with the active material layers 62. The solid electrolyte separator 66 is then laminated onto one of the active material layers 62 at an intermediate pressure. As with the anode unit 68, the top and bottom surfaces of the cathode unit 70 are flat and hard. FIG. 3 shows how the anode and cathode units 68, 70 are stacked in an alternating pattern to form a solid-state battery 72. To complete construction, each of the current collectors 54 would be electrically connected to one another and each of the current collectors 60 would be electrically connected to one another.

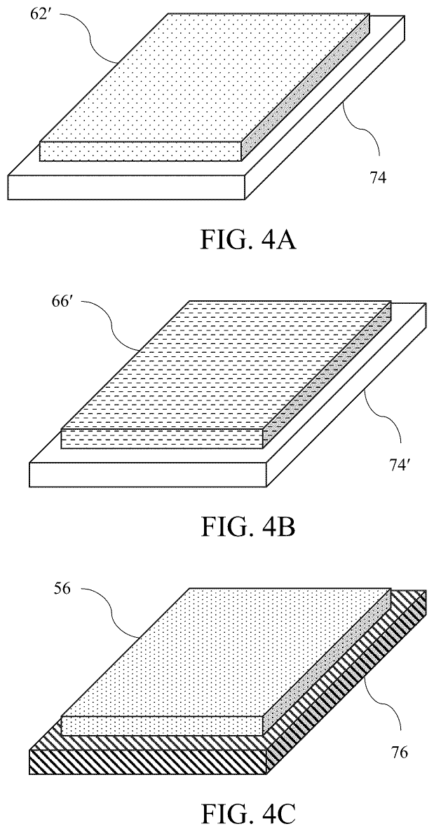

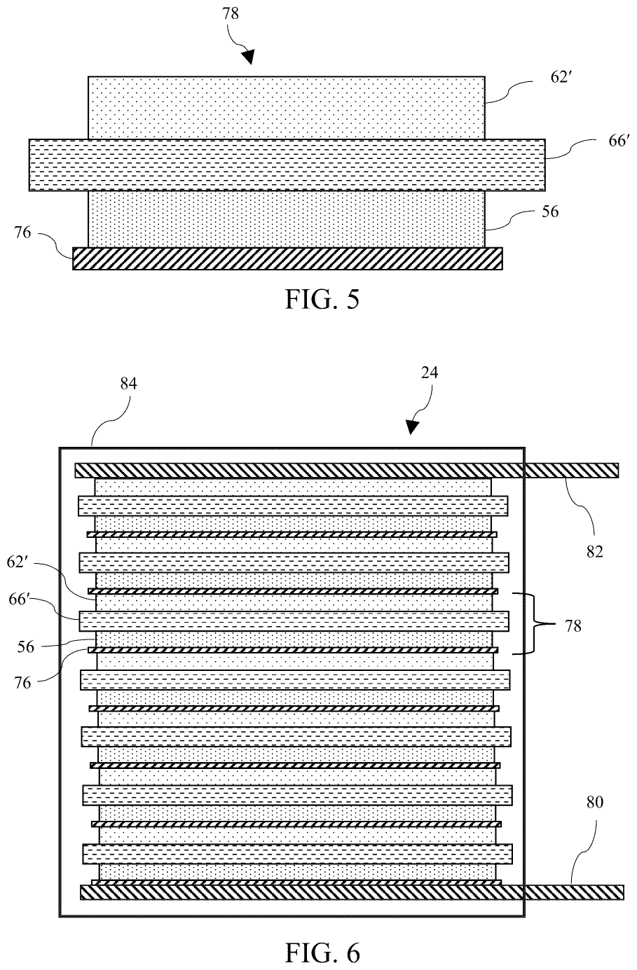

FIGS. 4A to 4C illustrate intermediate steps in a fabrication process for a unitized solid-state battery cell 78 shown in FIG. 5. As shown in FIG. 4A a carrier film 74 has been coated with a first active material, such as a positive active material. The carrier film may be, for example, a sheet of PET. This produces a free-standing electrode 62′. Similarly, as shown in FIG. 4B, a solid electrolyte separator 66′ has been coated onto a second sheet of carrier film 74′. As shown in FIG. 4C, the second active material 56, such as a negative active material, has been coated onto one side of an internal current collector 76 to form a single-sided electrode. The internal current collector 76 may be made of stainless steel, nickel film, nickel-coated copper film, or other suitable materials. The internal current 76 collector may be between 1.5 μm and 25 μm thick. A stainless steel current collector thinner than 5 μm is less in weight than an aluminum or copper current collector of comparable strength.

To complete fabrication of the unitized solid-state battery cell 78 of FIG. 5, the solid electrolyte separator 66′ is hot-pressed against the active material layer 56 and then the carrier film 74′ is removed. Then, the free standing electrode 62′ is hot-pressed against the solid-electrolyte separator 66′ and the carrier film 74 is removed. Finally, a pressure of about 50 to 300 MPa is applied to densify the layers. The single-sided electrode may be a negative electrode while the free-standing electrode may be a positive electrode. In other embodiments, the single-sided electrode may be a positive electrode while the free-standing electrode may be a negative electrode.

A series connected solid-state traction battery 24 of FIG. 6 is assembled by stacking a set of the unitized solid-state cells 78 with the internal current collector 76 of each cell, except the bottom cell, pressed against the layer 62′ of an adjacent cell. A current collector 80 is added to the bottom of the stack in contact with the internal current collector 76 of the bottom unitized cell 78. A current collector 82 is added to the top of the stack in contact with the layer 62′ of the top unitized cell 78. The current collectors 80, 82, unlike the internal current collectors 76, have tabs that extend beyond the boundaries of the unitized cells 78. The stack in subjected to a pressure between about 300 and 500 MPa and placed into an air-tight housing 84. The tabs of the current collectors 80, 82 penetrate the housing 84 and provide electrical terminals for the completed battery. Although the top surface of the positive electrode is flat and hard, it is part of an electron conducting interface as opposed to being part of an ion conducting interface. All ion conducting interfaces are contained within individual unitized solid-state cell and are densified together, yielding superior ion migration properties.

The unitized solid-state cells 78 can also be used to construct a parallel-connected battery. To produce a parallel-connected battery, the orientation of cells alternates such that internal current collectors are adjacent to internal current collectors of adjacent cells and positive active material layers are adjacent to positive active material layers of adjacent cells. In addition to the current collector 82 on the top, additional current collectors are added between adjacent positive active material layers. Similarly, in addition to the current collector 80 on the bottom, additional current collectors are added between adjacent internal current collectors 76. Alternatively, the internal current collectors 76 could be provided with tabs extending beyond the other layers to serve as the current collectors 80. The series and parallel structures may be used in combination. For example, a stack of twelve cells may be organized as four groups each having three cells with the groups of three connected to one another in series and the four groups connected in parallel.

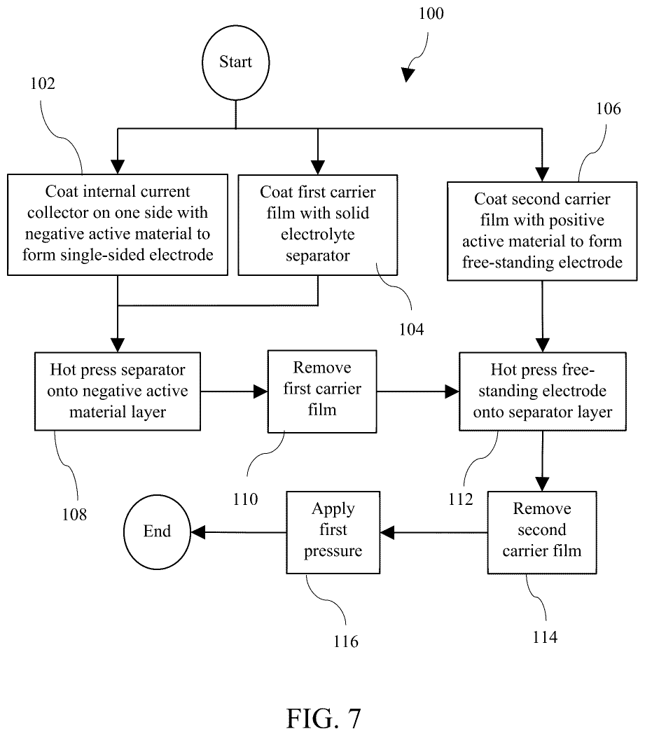

FIG. 7 is a flow chart for a process 100 of fabricating the unitized solid-state battery cell 78. At 102, the internal current collector 76 is coated with the negative active material layer 56 to form a single-sided electrode. At 104, the SE separator 66′ is formed by coating the carrier film 74′. Similarly, at 106, the free-standing electrode 62′ is formed by coating the carrier film 74 with a positive active material. The solid electrolyte separator 66′ is hot-pressed to the negative active material layer 56 at 108 and the carrier film 74′ is removed at 110. Similarly, the free-standing electrode 62′ is hot-pressed to the solid separator layer 66′ at 112 and the carrier film 74 is removed at 114. At 116, the assembly is subjected to a first pressure of 50 to 300 MPa to densify the layers. In some embodiments, the negative active material layer and the positive active material layer may be reversed.

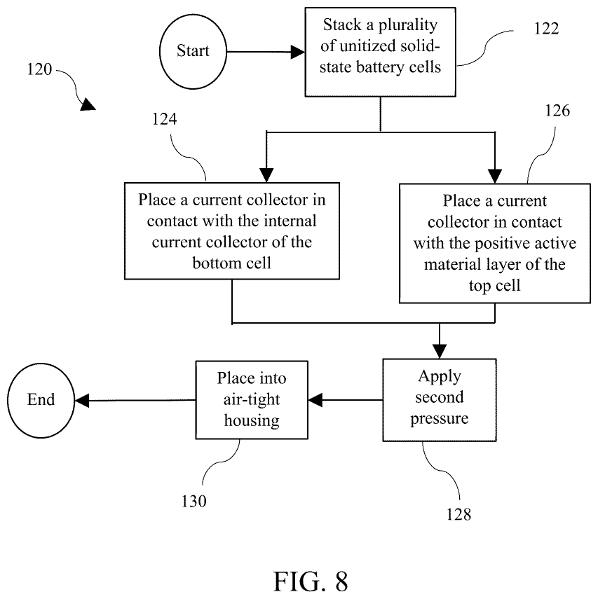

FIG. 8 is a flow chart for a process 120 for assembling a solid-state battery using the unitized solid-state cells 78 as depicted in FIG. 5 and as fabricated by the process of FIG. 7. At 122, a plurality of the unitized cells 78 is stacked, such that the internal current collector 76 of each cell except a bottom cell is adjacent to the top layer of the cell beneath it. At 124, the current collector 80 is placed in electrical contact with the internal current collector 76 of the bottom cell. Similarly, at 126, the current collector 82 is placed in electrical contact with the top layer of the top cell. At 128, the cells 78 are subjected to a second pressure of about 300 to 500 MPa. At 130, the stack is placed into the air-tight housing 84, with tabs of the current collectors 80, 82 protruding to provide electrical connection points.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of fabricating a solid-state battery, the method comprising:
coating a current collector with a first active material to form a single-sided electrode;
coating a carrier film with a second active material to form a free-standing electrode; and
laminating a solid electrolyte separator between the single-sided electrode and free-standing electrode to form a unitized solid-state cell.

2. The method of claim 1, wherein the laminating includes laminating the solid electrolyte separator with the single-sided electrode to form a unit and then laminating the unit with the free-standing electrode.

3. The method of claim 1, wherein the laminating includes applying a first pressure between about 50 MPa and 300 MPa.

4. The method of claim 3 further comprising:
arranging a plurality of the unitized solid-state cells between a bottom current collector and a top current collector to form a stack; and
applying a second pressure greater than the first pressure to the stack.

5. The method of claim 4, wherein the second pressure is between about 300 MPa and 500 MPa.

6. The method of claim 4, wherein the current collectors of the unitized solid-state cells are tab free and the top current collector and the bottom current collector have tabs extending beyond perimeters of the unitized solid-state cells.

7. The method of claim 1, wherein the first active material is negative active material.

8. The method of claim 1, wherein the second active material is positive active material.

9. A unitized solid-state battery cell, comprising:
a current collector having an active material free side and being laminated on another side with a negative active material layer, a positive active material layer, and a solid electrolyte separator layer between the negative and positive active material layers such that one of the negative and positive active material layers is in direct contact with the current collector and the other of the negative and positive active material layers is not in direct contact with any current collector.

10. The unitized solid-state battery cell of claim 9, wherein the negative active material layer is in direct contact with the current collector.

11. The unitized solid-state battery cell of claim 9, wherein the current collector is stainless steel.

12. The unitized solid-state battery cell of claim 9, wherein the current collector is tab free.

13. A solid-state battery comprising:
a plurality of unitized solid-state battery cells compressed in a stack.

14. The solid-state battery according to claim 13, wherein each of the unitized solid-state battery cells has a current collector laminated on a first side with a negative active material layer, a positive active material layer, and a solid electrolyte separator layer between the negative and positive active material layers such that one of the negative and positive active material layers is in direct contact with the current collector.

15. The solid-state battery according to claim 14, wherein a second side of each of the current collectors is in direct contact with one of the negative active material layer or the positive active material layer of an adjacent cell.

16. The solid-state battery of claim 15 further comprising a top current collector and bottom current collector on opposite ends of the stack.

17. The solid-state battery of claim 16 further comprising an air-tight housing surrounding the stack.
